(19) United States
(12) Patent Application Publication
(10) Pub. No.: US 2026/0331121 A1
(43) Pub. Date: Oct. 22, 2026

(54) SYSTEMS AND METHODS FOR CAPTURING AUDIO EVIDENCE FROM MULTIPLE SOURCES

(71) Applicant: MOTOROLA SOLUTIONS, INC., Chicago, IL (US)

(72) Inventors: Cheah Heng Tan, Bayan Lepas (MY); Lubomir O. Harizanov, McKinney, TX (US); Tih Huang Yeoh, Kangar (MY)

(21) Appl. No.: 19/182,415

(22) Filed: Apr. 17, 2025

(51) Int. Cl. G10L 21/0216; H04R 3/00

(52) U.S. Cl. CPC G10L 21/0216; H04R 3/005; G10L 2021/02165; H04R 2460/01; H04R 2499/11

(57) ABSTRACT

A hybrid body camera and remote speaker microphone system is disclosed, comprising a video system, a remote speaker microphone system, and an audio processor. The audio processor is coupled to both the video recording system and the remote speaker microphone system, featuring multiple audio inputs. It is configured to receive and route audio signals between the systems, process these signals to enhance audio quality, and perform echo cancellation. The system allows for selective coupling of audio input devices, including front-facing and rear-facing microphones, to optimize audio capture. Additionally, a method for capturing audio evidence from multiple sources is described, involving the routing and processing of audio signals to ensure clarity and quality in audio recordings.

### BACKGROUND

Body worn cameras (BWCs) are often worn by public safety personnel to capture video and/or photographic evidence of the environment surrounding a public safety officer during an incident.

### BRIEF DESCRIPTION OF THE DRAWINGS

FIG. 1 illustrates a communication system, according to some examples.

FIG. 2 illustrates a block diagram of a hybrid body-worn camera (BWC), according to some examples.

FIG. 3 illustrates a block diagram of a radio device, according to some examples.

FIG. 4 illustrates a block diagram of system for capturing audio evidence from multiple sources using a hybrid body-worn camera, according to some examples.

FIG. 5 illustrates a method for capturing audio evidence from multiple sources, according to some examples.

FIG. 6 illustrates a block diagram of system for capturing audio evidence from multiple sources using a hybrid body-worn camera, according to some examples.

FIG. 7 illustrates a block diagram of system for capturing audio evidence from multiple sources using a hybrid body-worn camera, according to some examples.

Skilled artisans will appreciate that elements in the figures are illustrated for simplicity and clarity and have not necessarily been drawn to scale. For example, the dimensions of some of the elements in the figures may be exaggerated relative to other elements to help improve understanding of examples of the present disclosure.

The system, apparatus, and method components have been represented where appropriate by conventional symbols in the drawings, showing only those specific details that are pertinent to understanding the examples of the present disclosure so as not to obscure the disclosure with details that will be readily apparent to those of ordinary skill in the art having the benefit of the description herein.

### DETAILED DESCRIPTION

In recent years, the integration of audio and video recording devices has become increasingly important in various fields, particularly in law enforcement and security. Body-worn cameras have been widely adopted by police officers and security personnel to document interactions with the public, providing a reliable account of events that can be used as evidence in legal proceedings. These devices are designed to capture video footage along with ambient audio, ensuring that all aspects of an encounter are recorded. However, the challenge lies in balancing the need for clear audio communication with the requirement to capture all environmental sounds accurately.

Remote Speaker Microphones (RSMs) are another critical tool used by law enforcement and security personnel. These devices are designed to facilitate clear and intelligible communication over radio networks, often in noisy environments. The primary function of an RSM is to eliminate background noise and focus on the speaker's voice, ensuring that messages are transmitted clearly. However, when combined with body-worn cameras, the differing audio requirements of these devices can create conflicts. For instance, while body cameras need to capture all ambient sounds, RSMs aim to suppress them, leading to potential issues in capturing comprehensive audio evidence. This highlights the need for innovative solutions that can harmonize the audio capturing capabilities of both body cameras and RSMs, ensuring that all necessary audio information is preserved without compromising communication clarity.

To address these and other problems, systems and methods are provided herein for capturing audio evidence from multiple sources.

In some aspects, the techniques described herein relate to a hybrid body camera and remote speaker microphone system, including: a video system; a remote speaker microphone system; an audio processor coupled to the video system and the remote speaker microphone system, the audio processor including a first audio input and a second audio input; and a first audio input device coupled to the first audio input and the second audio input; wherein the audio processor configured to: receive a first audio signal at the first audio input and the second audio input; route the first audio signal received at the first audio input to the video system without processing the first audio signal; process the first audio signal received at the second audio input to generate a second audio signal; route the second audio signal to the remote speaker microphone system; further process the second audio signal to generate a third audio signal; and route the third audio signal to the video system.

In some aspects, the techniques described herein relate to a method for capturing audio evidence from multiple sources, the method including: receiving a first audio signal at a first audio input and a second audio input; routing the first audio signal received at the first audio input to a video system without processing the first audio signal; process the first audio signal received at the second audio input to generate a second audio signal; routing the second audio signal to a remote speaker microphone system; further processing the second audio signal to generate a third audio signal; and routing the third audio signal to the video system.

Examples are herein described with reference to flowchart illustrations and/or block diagrams of methods, apparatus (systems) and computer program products according to examples. It will be understood that each block of the flowchart illustrations and/or block diagrams, and combinations of blocks in the flowchart illustrations and/or block diagrams, can be implemented by computer program instructions. These computer program instructions may be provided to an electronic processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some examples, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or example discussed in this specification can be implemented or combined with any part of any other aspect or example discussed in this specification.

Further advantages and features consistent with this disclosure will be set forth in the following detailed description, with reference to the figures.

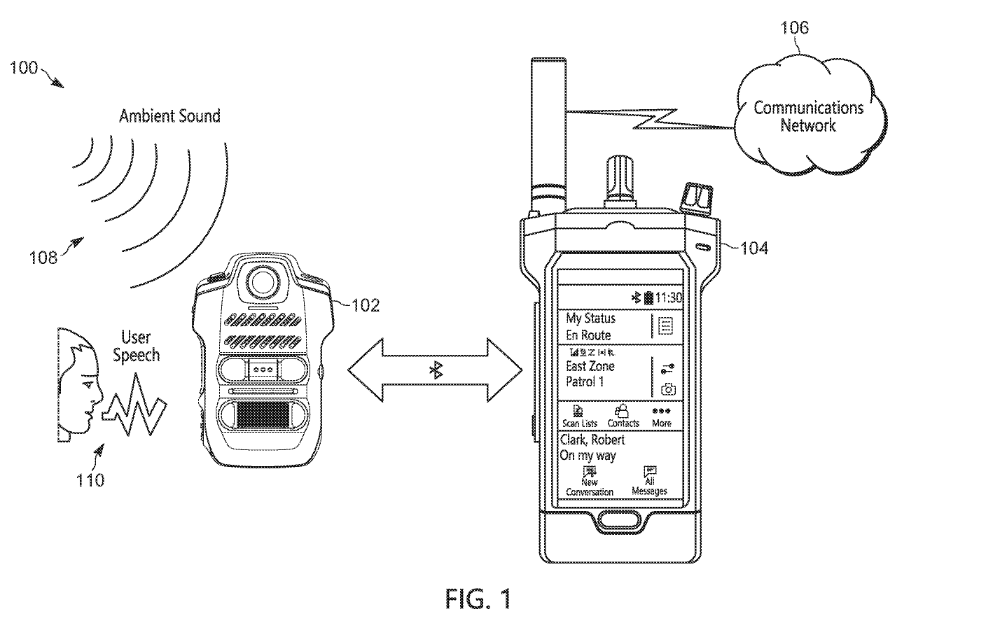

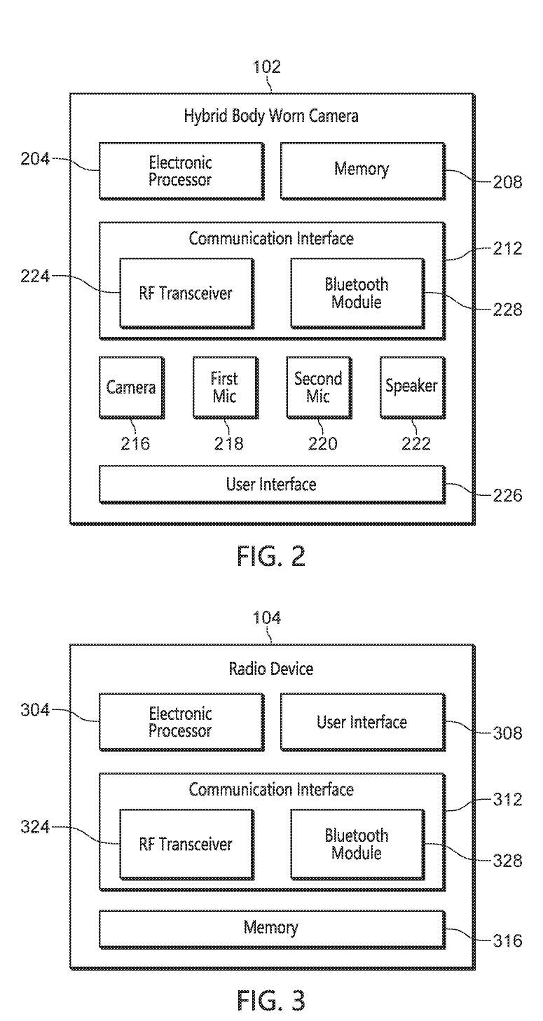

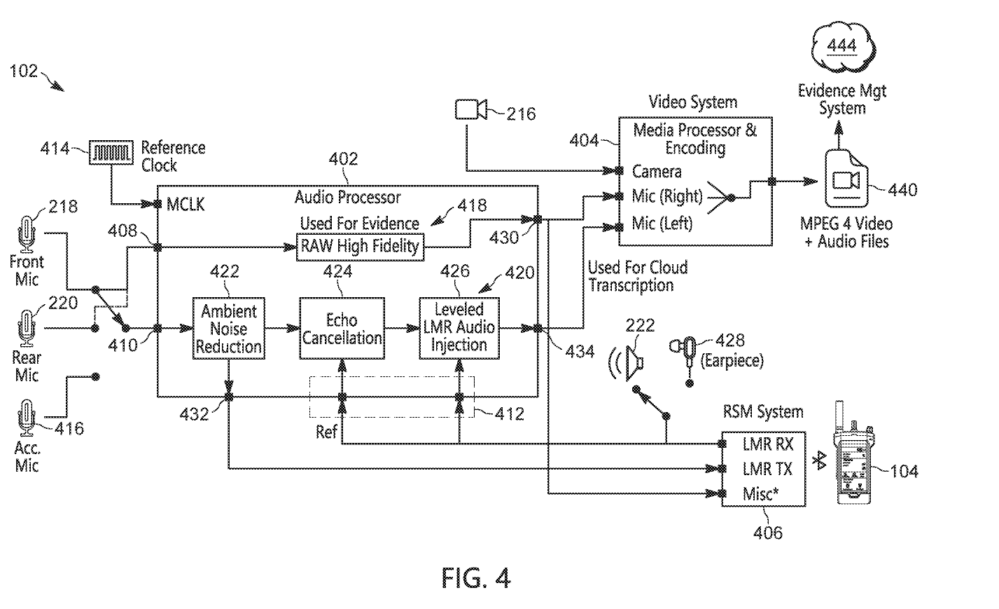

Referring now to the drawings, FIG. 1 illustrates a communication system 100. The system 100 includes a hybrid body-worn camera 102, described in greater detail below with respect to FIGS. 2 and 4, and a radio device 104, described in greater detail below with respect to FIG. 3. As used herein, the terms “hybrid body-worn camera” and “hybrid BWC” refer to a body-worn camera, which integrates components, features, and functions of a radio accessory. For example, as illustrated and described herein, the hybrid body-worn camera 102 integrates the hardware and functions of a remote speaker microphone.

As illustrated in FIG. 1, the hybrid body-worn camera 102 is communicatively coupled to the radio device 104 (e.g., using the Bluetooth™ wireless protocol). This allows the hybrid body-worn camera 102 to operate as a radio speaker microphone for the radio device 104.

The hybrid body-worn camera 102 may be worn by, for example, a public safety officer. The hybrid body-worn camera 102 records video footage of the environment surrounding the public safety officer (e.g., in response to the public safety officer pressing a button or other trigger to initiate recording). The public safety officer may also carry, wear, or otherwise be associated with the radio device 104 for communicating with a dispatch center or another public safety officer.

The public safety officer communicates using the hybrid body-worn camera 102 and radio device 104 over a communications network 106. The communication network 106 may include, for example, a land mobile radio (LMR) network, a broadband network, a Wi-Fi network, and/or other networks. For example, the radio device 104 may operate according to one or more of a variety of different communication protocols, for example, the Project 25 (P25) standard defined by the Association of Public Safety Communications Officials International (APCO), the TETRA standard defined by the European Telecommunication Standards Institute (ETSI), the Digital Private Mobile Radio (dPMR) standard also defined by the ETSI, the Digital Mobile Radio (DMR) standard also defined by the ESI, a long term evolution (LTE) protocol, LTE-Advanced or LTE-Advanced Pro compliant with, for example, the 3GPP TS 36 specification series, or the 5G (including a network architecture compliant with, for example, the 3GPP TS 23 specification series and a new radio (NR) air interface compliant with the 3GPP TS 38 specification series) standard, or a combination thereof, among other possibilities. In some instances, the hybrid body-worn camera 102 is also communicatively connected to a dispatch center or other remote system via the communication network 106 to transmit video footage, audio signals, and/or state information (e.g., recording state, battery state, etc.).

The hybrid body-worn camera 102 and radio device 104 may also be communicatively connected, over the communication network 106, to an evidence management system to transmit recorded audio and video data, along with metadata associated with the audio and video data, to, for example, an evidence management server (not shown).

As illustrated in FIG. 1, the hybrid body-worn camera 102 may sense (e.g., via one or more microphones) ambient sound 108 and user speech 110, which may be processed, routed, and/or recorded as described herein.

The system 100 may include more or fewer components than those illustrated in FIG. 1 and may perform additional functions other than those described herein.

FIG. 2 illustrates a simplified block diagram of the hybrid body-worn camera 102. In the example shown, the hybrid body-worn camera 102 includes a BWC electronic processor 204 (e.g., one or more BWC electronic processors 204) communicatively connected to a BWC memory 208, a BWC communication interface 212, a camera 216, an first microphone 218, a second microphone 220, a speaker 222 and a BWC user interface 226. The hybrid body-worn camera 102 may include more or fewer components than those illustrated in FIG. 2. The BWC communication interface 212 may communicatively connect the hybrid body-worn camera 102 to one or more remote devices or systems over the communication network 106, for example, using a radio frequency (RF) transceiver 224. The BWC may include more than one RF transceiver 224 and the RF transceiver 224 may include an LMR transceiver, a broadband transceiver, and/or the like. In some embodiments, one or more transmitter/receiver components may be used in addition to or in place of the combined transceiver(s). The BWC communication interface 212 also includes a Bluetooth™ module 228 for short-range communication with other devices, for example, the radio device 104. In some instances, the BWC communication interface 212 communicates with the radio device 104 using other short range communication means (e.g., WiFi™, ultra-wideband (UWB), and/or the like). The short-range communication between the hybrid body-worn camera 102 and the radio device 104 may be performed using one or more application programming interfaces (APIs) (e.g., a remote procedure call (RPC) API).

The communication interface 212 may implement more or fewer communication protocols than those described with respect to FIG. 2. For example, the BWC communication interface 212 may include a wired communication interface for wired communication with the radio device 104.

The camera 216 includes one or more image sensors for capturing image and video data of the environment surrounding a public safety officer that wears the hybrid body-worn camera 102. In some instances, the camera 216 also includes the first microphone 218, which may be a front-facing microphone, for recording audio of the environment surrounding the public safety officer. The BWC electronic processor 204 may activate a recording state of the camera 216 based on user input received from the BWC user interface 226. For example, the BWC user interface 226 may include a push button, a switch, or the like for initiating and/or terminating a BWC recording state of the camera 216. The BWC user interface 226 may also include, among other things, an indicator (e.g., an LED indicator or the like) that indicates whether the camera 216 is in a recording state.

The second microphone 220 may be positioned as a rear-facing microphone for receiving speech from a public safety officer when operating the hybrid body-worn camera 102 to transmit voice communications via the radio device 104. For example, the public safety officer may initiate a voice communication by pressing a push-to-talk (PTT) button of the user interface 226. In some embodiments, the hybrid body-worn camera 102 may include a third microphone (not shown) or inputs for receiving audio from a third microphone (e.g., integrated into an earpiece or other remote microphone device).

The speaker 222 is a loudspeaker for broadcasting audio received via the radio device 104. In some aspects, the speaker 222 may be muted when audio is provided via an attached earpiece accessory).

The BWC memory 208 stores information related to operation of the hybrid body-worn camera 102, such as program instructions that, when executed by the BWC electronic processor 204, cause the BWC electronic processor 204 to perform, among other things, methods described herein. The BWC memory 208 may further store BWC metadata related to operation of the hybrid body-worn camera 102. BWC metadata may include, for example, a BWC recording state of the camera 216, a timestamp associated with a start time of the BWC recording state, a state of charge of the hybrid body-worn camera 102, a signal strength received by the communication interface 212, and/or the like. The BWC memory 208 may also store video and audio captured by the hybrid body-worn camera 102, for example, in a removable non-volatile memory (e.g., an SD card).

FIG. 3 illustrates a simplified block diagram of the radio device 104. The radio device 104 includes a radio electronic processor 304 (e.g., one or more radio electronic processor 304) communicatively connected to a radio user interface 308, a radio communication interface 312, and a radio memory 316. The radio device 104 may include more or fewer components than those illustrates in FIG. 3. The radio communication interface 312 communicatively connects the radio device 104 to one or more dispatch centers and/or radio devices over the communication network 106 (e.g., using one or more RF transceivers 324). Accordingly, the RF transceiver 324 may include an LMR transceiver, a broadband transceiver, and/or the like. The RF transceiver 324, in some embodiments, may be replaced or supplemented with separate transmitter/receiver elements.

The radio communication interface 312 also includes a Bluetooth™ module 328 or other short range communication module for short-range communication with the hybrid body-worn camera 102. The radio communication interface 312 may also include other suitable wired or wireless communication interfaces than those described with respect to FIG. 3.

The RF transceiver 324 receives and transmits audio signals over the communication network 106. For example, the radio user interface 308 may include one or more audio input interfaces (e.g., microphones) and one or more audio output interfaces (e.g., speakers, earpieces, headsets, and the like) for receiving and outputting audio data. In some instances, the audio input interface and/or audio output interface are wirelessly connected to the radio electronic processor 304 via the radio communication interface 312.

The radio electronic processor 304 may also receive sensor data from one or more sensors (e.g., a gun draw sensor, a taser deploy sensor, etc.) associated with the first responder via the radio communication interface 312.

The radio memory 316 stores information related to the operation of the radio device 104, such as program instructions that, when executed by the radio electronic processor 304, cause the radio electronic processor 304 to perform, among other things, methods described herein.

FIG. 4 is a block diagram illustrating another example of the hybrid body-worn camera 102. In the illustrated example, the hybrid body-worn camera 102 includes an audio processor 402, a video system 404, and a radio speaker microphone (RSM) system 406. In some aspects, each of the audio processor 402, the video system 404, and the RSM system 406 are implemented on one or more discrete electronic processors. For example, the audio processor 402 may be a dedicated digital signal processor. In some aspects, some or all of the audio processor 402, the video system 404, and the RSM system 406, and/or their respective functions, may be implemented in software on one or more electronic processors (e.g., the electronic processor 204), systems on a chip (SOC), and the like.

As shown in FIG. 4, the audio processor 402, the video system 404, and the RSM system 406 are communicatively coupled and configured to send and receive audio signals to and from each other. Although not illustrated, the components are also configured to exchange various control and data signals with each other to accomplish the methods and functions described herein. In some aspects, as illustrated in FIG. 4, the audio processor 402 is configured to operate (e.g., to receive, process, and route audio signals) with its own reference clock 414, which may be separate from any other clock signals present in the hybrid body-worn camera 102.

The audio processor 402 includes a first audio input 408, a second audio input 410, and a third audio input 412. In some aspects, the first microphone 218 is permanently coupled to the first audio input 408. The audio processor 402 is configured to selectively couple the second audio input 410 to either one of the first microphone 218, the second microphone 220, or an accessory microphone 416 (e.g., a microphone of the earpiece accessory 428). In some aspects, the first microphone 218 provides audio signals to both the first audio input 408 and the second audio input 410. In other aspects, the first microphone 218 may provide audio signals to the first audio input 408, while the second microphone 220 provides audio signals to the second audio input 410.

In some configurations, the first audio input 408 includes two channels (e.g., a first channel and a second channel, or a left channel and a right channel). The first microphone 218 may be permanently coupled to the first channel and the second microphone 220 may be permanently coupled to the second channel. In such configurations, the audio processor 402 is configured to selectively receive audio signals at the first audio input 408 from either the first channel or the second channel.

Audio signals received at the first audio input 408 are received and routed in a raw, unprocessed format via an unprocessed audio path 418. In some respects, these unprocessed audio signals are more suitable for use as evidence in an investigation or other legal proceedings. These audio signals include ambient sounds (e.g., background noise, the voices of nearby speakers, and the like), speech from a user of the hybrid body-worn camera 102 as an RSM, and sound from the speaker 222 (e.g., as received via the radio device 104). In this way, these audio signals represent the complete audio environment surrounding the public safety officer user of the hybrid body-worn camera 102. The audio processor 402 is configured to route the unprocessed audio to the video system 404 via the unprocessed audio path 418 and the first audio output 430. In some aspects, the unprocessed audio signals are received by a right channel of a microphone of the video system 404. The unprocessed audio signal is recorded along with video signals received from the camera 216 and stored (e.g., as MPEG-4 files 440) in the memory 208. The files may be transmitted to an evidence management system 444 through appropriate means.

Accurate transmission of voice by the radio device 104 (e.g., over an LMR network) is facilitated by isolating the speech of the transmitting user from the background noise. Accordingly, the audio processor 402 includes a processed audio path 420 for providing processed audio signals to the RSM system 406 for transmission by the radio device 104. As illustrated in FIG. 4, audio signals received at second audio input 410 are processed using one or more of an ambient noise reduction process 422, an echo cancellation process 424, and a leveled audio injection process 426, as described herein.

In some aspects, as described herein, audio signals received at second audio input 410 are processed using the ambient noise reduction process 422 to produce processed audio signals, which are routed to the RSM system 406 via a second audio output 432. In some aspects, the processed audio signals are received by a left channel of a microphone of the video system 404. The processed audio signal is recorded along with video signals received from the camera 216 and the unprocessed audio signals and stored (e.g., as MPEG-4 files 440) in the memory 208. In this way, one track of the audio of the video system 404 may include ambient sounds, while another track includes processed speech signals, which are suitable for transcription.

The speech communications to and from the radio device 104 may be transcribed as part of evidence processing. In some aspects, the RSM system 406 routes its received audio signals (e.g., a reference audio signal) to the third audio input 412 of the audio processor 402. After performing echo cancellation (to reduce the audio received from the speaker 222 via a microphone coupled to the second audio input 410) and leveled audio injection (e.g., to produce a processed audio signal that includes intelligible speech received from the radio device 104), the processed audio is routed to the video system 404 (e.g., via a third audio output 434).

As illustrated in FIG. 4, the audio processor 402 may also route unprocessed audio signals to the RSM system 406 (e.g., via the first audio output 430), for analysis as described herein.

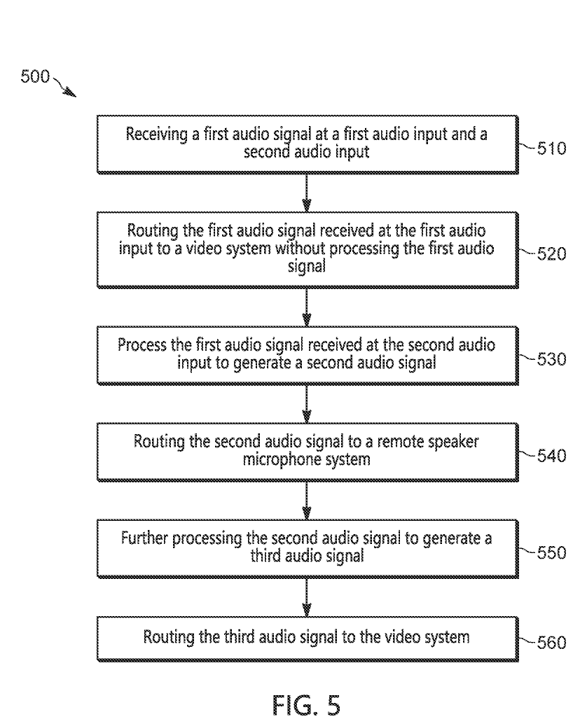

FIG. 5 is a flowchart of an example method 500 for capturing audio evidence from multiple sources. Although the method 500 is described in conjunction with the system 100 and the hybrid body-worn camera 102 as described herein, the method 500 could be used with other systems and devices. In addition, the method 500 may be modified or performed differently than the specific example provided. As an example, the method 500 is described as being performed by a hybrid body-worn camera 102 and, in particular, by the audio processor 402. However, it should be understood that, in some embodiments, portions of the method 500 may be performed in part by other devices, including for example, the radio device 104.

At block 510, the audio processor 402 receives a first audio signal at two audio inputs (e.g., the first audio input 408 and the second audio input 410). In some aspects, the same audio source (e.g., the first microphone 218) provides the signal to both audio inputs. In some aspects, the audio processor 402 is configured to selectively couple the second audio input to either a first audio input device (e.g., the first microphone 218), a second audio input device (e.g., the second microphone 220), or a third audio input device (e.g., the accessory microphone 416).

In some aspects, the first audio signal received at the first audio input 408 may be received from one of multiple sources. For example, the first audio input 408 may include two channels, as described in FIG. 4, with a first audio input device (e.g., the first microphone 218) permanently coupled to the first channel and a second audio input device (e.g., the second microphone 220) permanently coupled to the second channel.

In some aspects, the audio processor 402 may analyze the signals received on the first and second channels (e.g., for audio levels, fidelity, and the like) and selectively receive the first audio signal from either the first channel or the second channel based on the analysis. For example, one of the microphones may be damaged or otherwise not producing a usable audio signal. In another example, audio received from the front microphone may be overwhelmed by environmental noise, making the audio less intelligible than audio received from the rear microphone.

At block 520, the audio processor 402 routes the first audio signal received at the first audio input to a video system without processing the first audio signal. For example, as illustrated in FIG. 4, the first audio signal may be routed via the unprocessed audio path 418 to the video system 404 via the first audio output 430.

In some aspects, the audio processor 402 may also route the first audio signal may be routed via the unprocessed audio path 418 to RSM system 406 via the first audio output 430. The RSM system 406 is configured to analyze the unprocessed audio (e.g., for audio levels, fidelity, and the like). Based on the results of this analysis, the RSM system 406 may signal the audio processor 402 that the unprocessed audio either meets or fails to meet a predetermined quality standard. The audio processor 402 may be configured to selectively couple the first audio input to either one of the first microphone 218 or the second microphone 220 based on an analysis of the first audio signal performed by the remote speaker microphone system.

At block 530, audio processor 402 processes the first audio signal received at the second audio input 410 to generate a second audio signal. For example, the audio processor 402 may process the first audio signal by suppressing ambient audio noise to enhance a user’s voice present in the first audio signal using the ambient noise reduction process 422. In some aspects, ambient noise reduction is performed continuously on audio received at the second audio input 410. In other aspects, ambient noise reduction is triggered when the RSM system 406 operates in transmit mode (e.g., in response to a PTT signal).

At block 540, audio processor 402 routes the second audio signal to the remote speaker microphone system 406. For example, the audio processor 402 may route the noise-reduced speech signals to the RSM system 406 via the second audio output 432.

At block 550, the audio processor 402 performs further processing on the second audio signal to generate a third audio signal. For example, during reception of audio from the radio device 104 (e.g., from the speaker 222 received at one or both of the first microphone 218 and the second microphone 220), the audio processor 402 may receive, at third audio input 412, a reference audio signal from the remote speaker microphone system 406. This reference audio signal contains the same audio being broadcast over the speaker 222. In some aspects, the audio processor 402 generates the third audio signal by performing echo cancellation (e.g., using the echo cancellation process 424) on the second audio signal based on the reference audio signal. Optionally, or in addition, the audio processor 402 may generate the third audio signal by injecting the reference audio signal into the second audio signal at a predetermined level (e.g., using the leveled audio injection process 426). By performing this processing, the audio processor 402 can mitigate situations where the audio received from the radio device 104 is so loud that it affects the intelligibility of the speech in the audio received at the second audio input 410. Similarly, in instances where the audio output is routed to the earpiece accessory 428, the leveled audio injection process 426 ensures that the received audio is present in the processed signal recorded at the video system 404.

In some instances, the unprocessed audio path 418 may be overloaded by loudspeaker audio. In such instances, because the echo cancellation process 424 is used to reduce audio levels from the speaker 222, the audio processor 402 may be configured to reduce the amount of ambient noise reduction performed on the processed audio path 420 during audio reception to ensure that ambient sounds are still recorded.

At block 560, the audio processor 402 routes the third audio signal to the video system 404. For example, the audio processor 402 may output the processed audio signals at the third audio output 434.

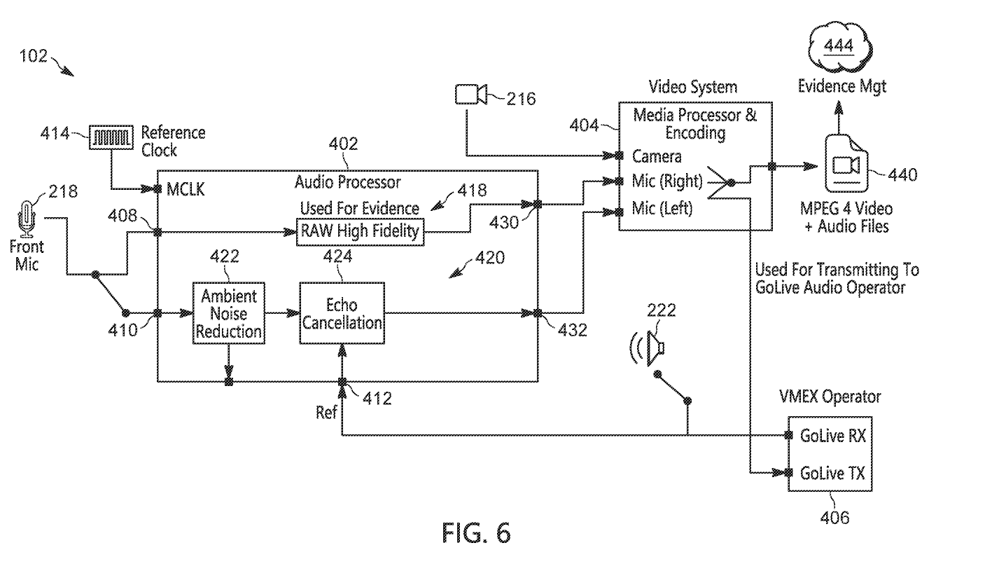

FIG. 6 illustrates an alternative embodiment of the hybrid body-worn camera 102, which is configured for full-duplex (e.g., using VOX or always on) with a video manager (VMEX) operator. In the illustrated embodiment, a single microphone (e.g., the first microphone 218) is coupled to the first audio input 408 and the second audio input 410. The audio signals are received and routed via the unprocessed audio path 418 and the processed audio path 420, as described herein.

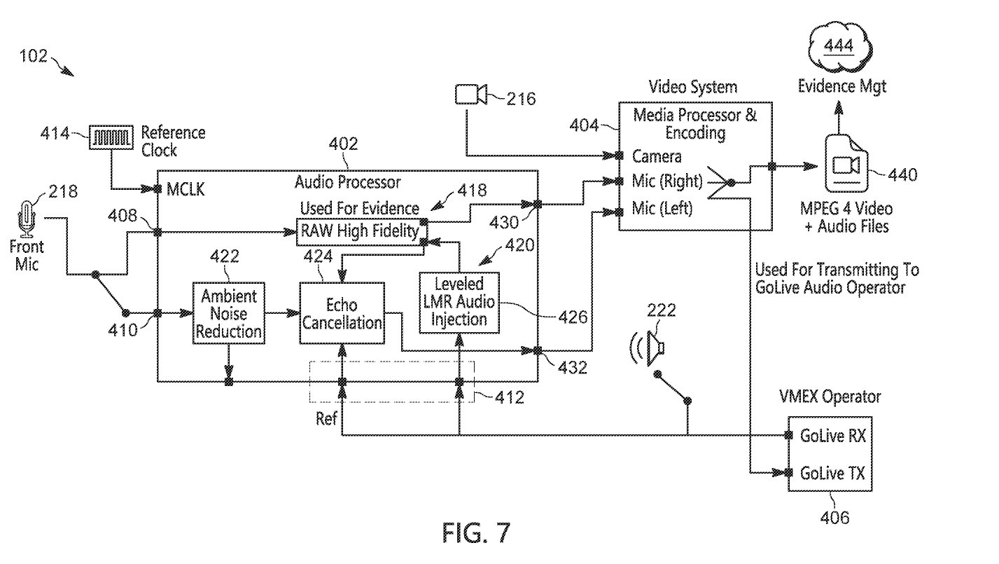

FIG. 7 illustrates an alternative embodiment of the hybrid body-worn camera 102 illustrated in FIG. 6. In the illustrated embodiment, echo cancellation and reinjection of the received signal are performed. The audio processor 402 is configured to perform this processing where masking prevents reception of the received audio signals from the RSM system 406 through the ordinary path (e.g., from the speaker 222 to the first microphone 218).

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot wirelessly transmit or receive electronically encoded video and/or audio, etc., and cannot perform radio communication, record and share audio data, record and share video data, or process audio signals, among other features and functions set forth herein).

In the foregoing specification, various examples have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises …a,” “has …a,” “includes …a,” “contains …a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if examples described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some examples may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an example can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

The terms “substantially,” “essentially,” “approximately,” “about” or any other version thereof, are defined as being close to as understood by one of ordinary skill in the art, and in one non-limiting example the term is defined to be within 10%, in another example within 5%, in another example within 1% and in another example within 0.5%. The term “one of,” without a more limiting modifier such as “only one of,” and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled,” “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A hybrid body camera and remote speaker microphone system, comprising:
a video system;
a remote speaker microphone system;
an audio processor coupled to the video system and the remote speaker microphone system, the audio processor including a first audio input and a second audio input; and
a first audio input device coupled to the first audio input and the second audio input;
wherein the audio processor configured to:
receive a first audio signal at the first audio input and the second audio input;
route the first audio signal received at the first audio input to the video system without processing the first audio signal;
process the first audio signal received at the second audio input to generate a second audio signal;
route the second audio signal to the remote speaker microphone system;
further process the second audio signal to generate a third audio signal; and
route the third audio signal to the video system.

2. The system of claim 1, wherein processing the first audio signal includes suppressing ambient audio noise to enhance a user’s voice present in the first audio signal.

3. The system of claim 1, wherein:
the audio processor further comprises a third audio input; and
the audio processor is configured to:
receive, at the third audio input a reference audio signal from the remote speaker microphone system; and
generate the third audio signal by performing echo cancellation on the second audio signal based on the reference audio signal.

4. The system of claim 3, wherein generating the third audio signal further includes injecting the reference audio signal into the second audio signal at a predetermined level.

5. The system of claim 1, wherein the first audio input device is a front-facing microphone permanently coupled to the first audio input.

6. The system of claim 5, wherein the first audio input device is selectively coupled to the second audio input.

7. The system of claim 1, further comprising:
a second audio input device;
wherein the audio processor is configured to selectively couple the second audio input to either the first audio input device or the second audio input device.

8. The system of claim 7, further comprising a third audio input device, wherein the audio processor is configured to selectively couple the second audio input to one of the group comprising the first audio input device, the second audio input device, and the third audio input device.

9. The system of claim 8, wherein each of the second audio input device and the third audio input device are one of a rear-facing microphone and an accessory microphone.

10. The system of claim 1, further comprising:
a second audio input device, wherein
the first audio input includes a first channel and a second channel;
the first audio input device is permanently coupled to the first channel;
the second audio input device is permanently coupled to the second channel; and
the audio processor is configured to selectively receive the first audio signal from either the first channel or the second channel.

11. The system of claim 10, further comprising a second audio input device, wherein:
the first audio input device is a front-facing microphone;
the second audio input device is a rear-facing microphone;
the audio processor is configured to:
route the first audio signal received at the first audio input to the remote speaker microphone system without processing the first audio signal; and
selectively couple the first audio input to either one of the first audio input device or the second audio input device based on an analysis of the first audio signal performed by the remote speaker microphone system.

12. A method for capturing audio evidence from multiple sources, the method comprising:
receiving a first audio signal at a first audio input and a second audio input;
routing the first audio signal received at the first audio input to a video system without processing the first audio signal;
process the first audio signal received at the second audio input to generate a second audio signal;
routing the second audio signal to a remote speaker microphone system;
further processing the second audio signal to generate a third audio signal; and
routing the third audio signal to the video system.

13. The method of claim 12, wherein processing the first audio signal includes suppressing ambient audio noise to enhance a user’s voice present in the first audio signal.

14. The method of claim 12, further comprising:
receiving, at a third audio input a reference audio signal from the remote speaker microphone system; and
generating the third audio signal by performing echo cancellation on the second audio signal based on the reference audio signal.

15. The method of claim 14, wherein generating the third audio signal includes injecting the reference audio signal into the second audio signal at a predetermined level.

16. The method of claim 12, wherein receiving the first audio signal at the first audio input includes receiving the first audio signal from a front-facing microphone permanently coupled to the first audio input.

17. The method of claim 12, wherein receiving the first audio signal at the second audio input includes receiving the first audio signal from a front-facing microphone selectively coupled to the first audio input.

18. The method of claim 12, further comprising:
routing the first audio signal received at the first audio input to the remote speaker microphone system without processing the first audio signal; and
selectively coupling the first audio input to either one of a first audio input device or a second audio input device based on an analysis of the first audio signal performed by the remote speaker microphone system.

19. The method of claim 12, further comprising:
selectively receiving the first audio signal from either a first channel of the first audio input permanently coupled to a front-facing microphone or a second channel of a first audio input permanently coupled to a rear-facing microphone.

20. The method of claim 12, further comprising:
selectively coupling the second audio input to one of the group comprising a first audio input device, a second audio input device, and a third audio input device.
